(19) United States
(12) Patent Application Publication
(10) Pub. No.: US 2026/0039923 A1
(43) Pub. Date: Feb. 5, 2026

(54) DYNAMIC ARTIFICIAL INTELLIGENCE SEARCHING AND DISPLAY

(71) Applicant: Sony Group Corporation, Tokyo (JP)

(72) Inventors: James R. Milne, Ramona, CA (US); Justin Kenefick, San Diego, CA (US); William Clay, San Diego (UA); Marvin DeMerchant, San Diego, CA (US)

(73) Assignee: Sony Group Corporation, Tokyo (JP)

(21) Appl. No.: 18/791,187

(22) Filed: Jul. 31, 2024

(51) Int. Cl. H04N 21/81; H04N 21/84

(52) U.S. Cl. CPC H04N 21/8133; H04N 21/84

(57) ABSTRACT

Implementations generally relate to dynamic artificial intelligence searching and display. In some implementations, a method includes detecting that a media item is being presented on a media device. The method further includes generating media information associated with the media item while the media item is being presented on the media device. The method further includes providing the media information to a user of the media device.

### BACKGROUND

When a person watches a media item such as a movie or television show, the person can search for information about the media item by performing a search on the internet using a stand-alone device such as a smartphone. Through the search, the person may find related information about the media item such as actors, directors, related news, etc.

### SUMMARY

Implementations generally relate to artificial intelligence searching and display. In some implementations, a system includes one or more processors, and includes logic encoded in one or more non-transitory computer-readable storage media for execution by the one or more processors. When executed, the logic is operable to cause the one or more processors to perform operations including: detecting that a media item is being presented on a media device; generating media information associated with the media item while the media item is being presented on the media device; and providing the media information to a user of the media device.

With further regard to the system, in some implementations, the media item is a movie or a television show. In some implementations, the media information includes people information about people associated with a creation of the media item. In some implementations, the media information includes content information about content associated with the media item. In some implementations, the logic when executed is further operable to cause the one or more processors to perform operations including performing a search for media information based on content associated with the media item, where the content is currently being presented on the media device. In some implementations, the logic when executed is further operable to cause the one or more processors to perform operations including displaying the media information to the user, where the media information is displayed based on content that is currently being presented on the media device. In some implementations, the logic when executed is further operable to cause the one or more processors to perform operations including performing an analysis of the media information while the media item is being presented to a user.

In some implementations, a non-transitory computer-readable storage medium with program instructions thereon is provided. When executed by one or more processors, the instructions are operable to cause the one or more processors to perform operations including: detecting that a media item is being presented on a media device; generating media information associated with the media item while the media item is being presented on the media device; and providing the media information to a user of the media device.

With further regard to the computer-readable storage medium, in some implementations, the media item is a movie or a television show. In some implementations, the media information includes people information about people associated with a creation of the media item. In some implementations, the media information includes content information about content associated with the media item. In some implementations, the instructions when executed are further operable to cause the one or more processors to perform operations including performing a search for media information based on content associated with the media item, where the content is currently being presented on the media device. In some implementations, the instructions when executed are further operable to cause the one or more processors to perform operations including displaying the media information to the user, where the media information is displayed based on content that is currently being presented on the media device. In some implementations, the instructions when executed are further operable to cause the one or more processors to perform operations including performing an analysis of the media information while the media item is being presented to a user.

In some implementations, a computer-implemented method includes: detecting that a media item is being presented on a media device; generating media information associated with the media item while the media item is being presented on the media device; and providing the media information to a user of the media device.

With further regard to the method, in some implementations, the media item is a movie or a television show. In some implementations, the media information includes people information about people associated with a creation of the media item. In some implementations, the media information includes content information about content associated with the media item. In some implementations, the method further includes performing a search for media information based on content associated with the media item, where the content is currently being presented on the media device. In some implementations, the method further includes displaying the media information to the user, where the media information is displayed based on content that is currently being presented on the media device.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example media environment, which may be used for some implementations described herein.

FIG. 2 is a block diagram of an example network environment, which may be used for some implementations described herein.

FIG. 3 is an example flow diagram for artificial intelligence searching and display, according to some implementations.

FIG. 4 is a block diagram of example media information displayed in a user interface, which may be used for some implementations described herein.

FIG. 5 is a block diagram of an example network environment, which may be used for some implementations described herein.

FIG. 6 is a block diagram of an example computer system, which may be used for some implementations described herein.

### DETAILED DESCRIPTION

Implementations described herein enable, facilitate, and manage dynamic artificial intelligence searching and display. Implementations use artificial intelligence (AI) to search for information about a media item such as a move or television show that a user is currently watching. The AI automatically finds related content about the media item, such as actors, directors, producers, etc. as well as additional media items associated with the current media item that user is watching.

In some implementations, a system detects that a media item is being presented on a media device. The system further generates media information associated with the media item while the media item is being presented on the media device. The system further provides the media information to the user of the media device.

Although implementations disclosed herein is described in the context of movies and television shows, the implementations may also apply to other types of media items such a music, commercial, advertisements, etc.

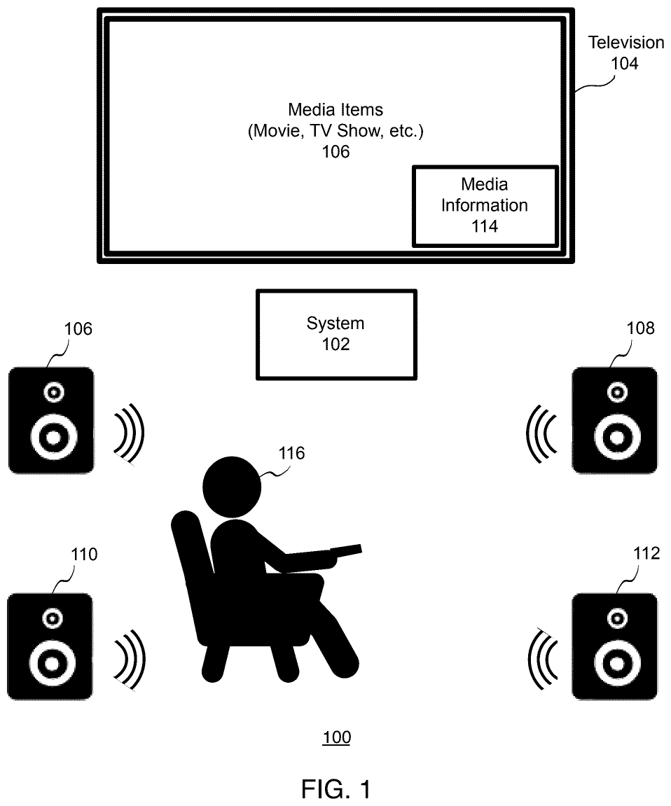

FIG. 1 is a block diagram of an example media environment 100, which may be used for some implementations described herein. In some implementations, media environment 100 includes a system 102, which included artificial intelligence for executing implementations described herein. Media environment 100 also includes a television 104. While some implementations are described herein in the context of a television, these implementations and others apply to different types of media devices such as smartphones, computers, tablets, etc. Also shown are speakers 106, 108, 110, and 112, which provide sound from television 104.

As described in more detail herein, television 104 presents media items such as movies, television shows, music, etc. System 102 provides media information 114 to a user 116 watching a media item that is being presented on television 104.

In various implementations, system 102 may present the media information on the main screen of television 104, on a secondary screen, or on an augmented screen if the user is watching the media item through mixed reality glasses. The AI of system 102 may also discover all possible secondary screens that are connected to the media environment as potential screens for presenting the media information. In various implementations, the AI of system 102 queries devices in the media environment to discover which ones are capable of displaying media information, as well as their location relative to the person requesting information. This enables convenient viewing of the media information by the user. In various implementations, the AI may ask the user which display device is desirable for presenting the media information. In various implementations, system 102 may enable the user to set ahead of time which display device to use for presenting media information. In some implementations, system 102 may alternatively present media information to the user non-visually. For example, system 102 may utilize voice to convey media information to the user. In some implementations, system 102 may utilize voice in lieu of or in combination with visual media information. Implementations directed to media information 114 are described in more detail herein.

In the example shown, system 102 is separate from television 104. In various implementations, system 102 may be located in various optional places. For example, system 102 may reside or be integrated into television 104 or in another media device such as a smart phone, computer, tablet, medial controller, etc. If system 102 is separate from television 104 as shown, system 102 may communicate with television 104 via a suitable network, which may be any suitable communication network such as a Bluetooth network, a Wi-Fi network, the Internet, Bluetooth, ZigBee, ultra-wideband wireless technology (UWB) network, near-field communication (NFC) network, etc.

While system 102 performs implementations described herein, in other implementations, any suitable component or combination of components associated with system 102 or any suitable processor or processors associated with system 102 may facilitate performing the implementations described herein, such as the AI of system 102.

In the various implementations described herein, the processor of system 102 causes the elements described herein (e.g., movies, television shows, etc.) to be displayed in a user interface such as a user interface of television 102 on one or more display screens.

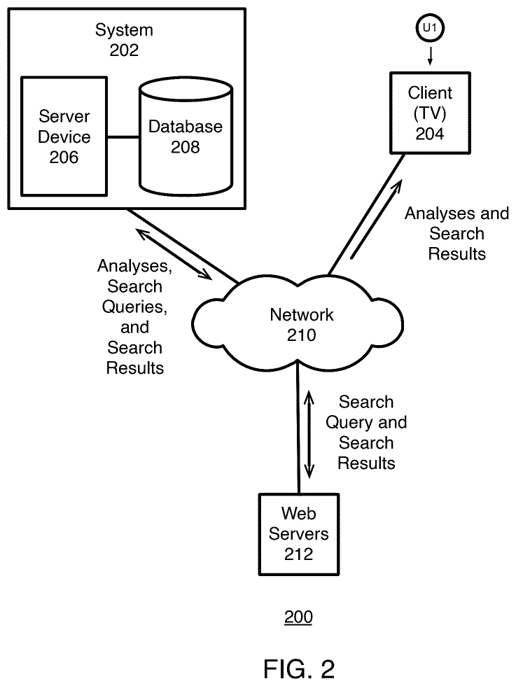

FIG. 2 is a block diagram of an example network environment 200, which may be used for some implementations described herein. In some implementations, media environment 200 includes a system 202 and a client 204, which may be used to implement system 102 and television (TV) 104 of FIG. 1, respectively.

System 202 includes a server device 206 and a database 208. Network environment 200 also includes a network 210 through which system 202, client 204, and one or more web servers 212 communicate. In various implementations, web servers 212 may include web servers associated with media streaming platforms. Such media streaming platforms provide media items such as movies, television shows, music, etc. Web servers 212 may also include sources of media information associated with one or more media items being presented on client (TV) 204.

As described in more detail herein, the AI of system 202 analyzes media items, including content of such media items. Content may include, for example, movies, television shows, etc. System 202 may also send search queries to web servers to fetch media information associated with the media items. System 202 receives search results from one or more web servers 212 based on the search queries. System 202 may store such media information in database 208 and send media information to client 204 to be presented to the user. The media information may include analyses and search results based on the search queries. Network 210 may be any suitable communication network such as a Bluetooth network, a Wi-Fi network, the Internet, etc. Example implementations directed to media information are described in more detail herein.

For ease of illustration, FIG. 2 shows one block for each of system 202, server device 206, and database 208, and shows two blocks for client device 204 and web servers 212. Blocks 202, 204, 206, 208, 210, and 212 may represent multiple systems, server devices, network databases, client devices, and web servers. In other implementations, environment 100 may not have all of the components shown and/or may have other elements including other types of elements instead of, or in addition to, those shown herein.

While system 202 performs implementations described herein, in other implementations, any suitable component or combination of components associated with system 102 or any suitable processor or processors associated with system 202 may facilitate performing the implementations described herein, such as the AI of system 202.

In the various implementations described herein, the processor of system 102 causes the elements described herein (e.g., movies, television shows, etc.) to be displayed in a user interface such as a user interface of client device 204 on one or more display screens.

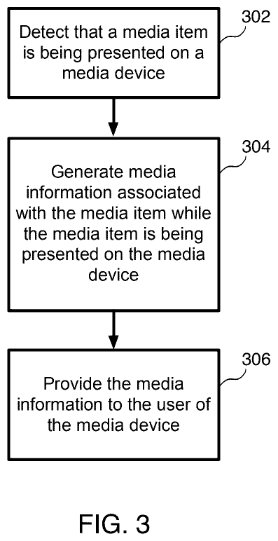

FIG. 3 is an example flow diagram for artificial intelligence searching and display, according to some implementations. Referring to both FIGS. 2 and 3, a method is initiated at block 302, where a system such as system 202 detects that a media item is being presented on a media device. As indicated herein, the media device may be one of several types of devices. For example, in various implementations, the media device may be a television, a smart phone, a computer, a tablet, etc. In various implementations, the media item is a movie or a television show, or other type of media such as music.

At block 304, system 202 generates media information associated with the media item while the media item is being presented on the media device. In various implementations, system 202 may generate the media information to answer a query made by the user. For example, the user may ask system 102 who an actor is who is playing a particular character. The user may ask system 102 what other movies or television shows that actor has acted in. In some implementations, system 202 may perform a search for media information associated with the media item while the media item is being presented on the media device. The search may be a search in a local database such as database 208 or a search from web servers 212 of FIG. 2. System 202 may fetch via the search different types of information associated with the media item. Example media information are described in more detail herein.

At block 306, system 202 provides the media information to the user of the media device. In some implementations, system 202 may store the media information for display to the user of the media device. For example, system 202 may store media information in a locat database such as database 208. Such media information may be preexisting in database 208 or may be procured from web servers 212 and then stored in database 208. System 202 may fetch the media information from database 208 and then display the media information on the client device 204 (e.g., television) for the user to view. Alternatively, system 202 may provide the media information by voice in lieu of or in combination with visual media information.

In various implementations, the AI of system 202 may retrieve information from multiple sources to build a database. A database may include television guide information, program stream meta data, transport stream metadata, as well as past databases created.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

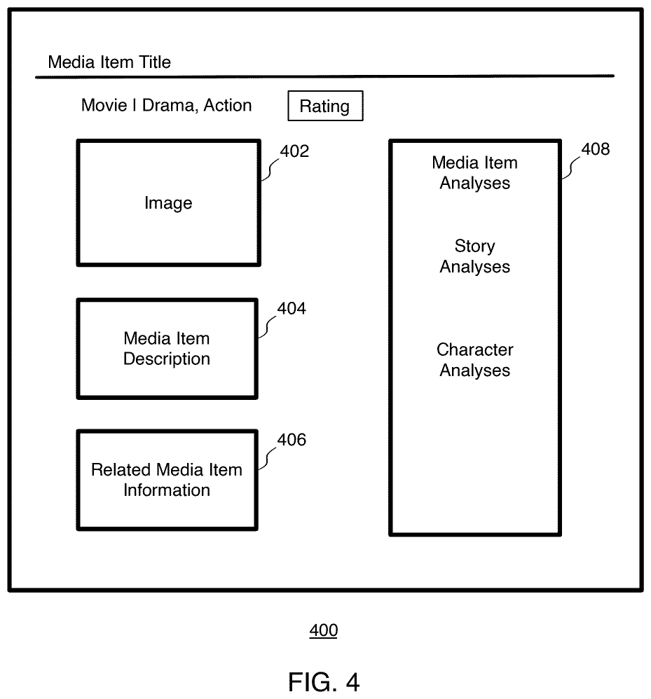

FIG. 4 is a block diagram of example media information displayed in a user interface 400, which may be used for some implementations described herein. As shown, the media information may include a media item title such as a title of a movie or title of a television show, etc. The media information may include a category of the media item (e.g., movie, television show, etc.). The media information may include a category of the media item (e.g., movie, television show, etc.). The media information may include a genre (e.g., drama, action, etc.) and a rating associated with the media item.

As shown, the media information may include an image 402 representing the media item, a media item description 402, related media item information 406, and media item analyses 408. Image 402 may include an image or poster image that represents the media item. The media item description 404 may include a synopsis of the story of the media item and other associated information. The related media item information 406 may include spin-off television shows, spin-off movies, sequels, or other productions associated with the media item. Example implementations directed to media item analyses 408 is described in more detail below.

In various implementations, the media information may include people information about people associated with a creation of the media item. In various implementations, the AI of system 202 automatically recognizes the cast and characters of the current show. As such, people information may include actors, directors, writers, and/or other people who contributed to the creation of the media item associated with the media item. Such people information may be included with the media item description 404 and/or the media item analyses 408.

In various implementations, the media information may include content information about content associated with the media item. Such content information may include story, plot, or other information associated with the media item. Such people information may be included with the media item description. Such content information may be included with the media item description 404 and/or the media item analyses 408.

In various implementations, the AI of system 202 performs the search for media information based on content associated with the media item, where the content is currently being presented on the media device. In various implementations, the AI of system 202 builds databases for individual movies, individual television shows and/or series, individual television seasons, etc. The AI may store such database(s) locally in database 208, for example, and/or in the cloud.

In various implementations, the AI of system 202 may share databases with other AI's, as permitted by the user. The AI of system 202 may retrieve other media information from other databases to create series or story arc synopsis for a particular television season and/or a complete television series.

In various implementations, the AI of system 202 displays the media information to the user, where the media information is displayed based on content that is currently being presented on the media device. Such media information may be presented with the media item description 404, with related media item information 406, and/or with the media item analyses 408.

In various implementations, the AI of system 202 performs an analysis of the media information while the media item is being presented to a user. In various embodiments, while the user is watching television 204, the AI of system 202 automatically analyzes the current media content being presented on television 204. The AI recognizes the media item (e.g., title of the movie, television show, etc.) and determines information about the creators of media item such as the cast, the director, the writer, etc. The AI also determines information about the content such as the characters, the story, etc. As such, the media item analyses may include story analyses (e.g., plot points, etc.) and character analyses.

In various implementations, the AI system 202 accesses this media information from local database 208 and/or fetches this media information from web servers across the internet based on the recognized information. The AI may also determine other information associated with the media content such as when the media content is available to be shown, future episodes of a television series, etc.

In various implementations, the AI of system 202 performs a scene analysis for each scene currently being presented on television 204 in real time. The AI of system 202 builds one or more databases and stores such analyses of the scenes. In various implementations, the AI of system 202 automatically and dynamically updates the media information as scenes change on television 204. The AI of system 202 captures the current scene and analyzes faces to understand which actors are present. For example, the AI may determine that a character John Smith was allegedly killed in episode 301, but later reappeared in episode 402. In some implementations, if the user asks for no plot spoilers, the AI may respond that the character John Smith died in episode 301, and not provide such information about episode 402. The AI of system 202 may also identify other movies or television shows that particular actors were in and the characters they played.

The AI of system 202 may analyze scenes from scene to scene as characters come and go, system 202 may inform the user in real time who the character on the screen are, as well as what actors are playing the characters. The AI of system 202 may perform character analyses for each character scene by scene. In some implementations, system may also provide media information associated with any commercials and/or advertising that is being presented during a given time on television 204.

In various implementations, the AI of system 202 enables the user to ask the AI to search for particular information associated with the media item (e.g., who the lead actors are, who the support actors are, questions about the story or narrative, etc.). The AI of system 202 may then fetch such media information from the local database or the internet.

In various implementations, the AI of system 202 builds a profile of the user, where the profile includes queries or questions that the user asks. As such, the AI of system 202 may automatically without user intervention build databases and provide similar search results for future media items that the user watches. As such, the media information provided by the AI of system 202 to the user is automatically tailored to the user.

The following are other implementations. In various implementations, the AI of system 202 may summarize what happened in previously watched portions of content. The AI of system 202 may provide information or statistics about sports or other events in real time or as queried by the user. The AI of system 202 may explain the content to the user, more than merely summarizing. For example, the AI of system 202 may explain possible motivations of a certain character. The AI of system 202 may monitor information about some system that is displayed on a screen, for example, monitoring pressure of a piping system. The AI of system 202 may provide a performance analysis of videogame gameplay.

Implementations described herein provide various benefits. For example, implementations provide a user with useful media information about media items such as movies, television shows, etc. Implementations described herein also provide media information that is relevant to the media item content that the user is currently watching.

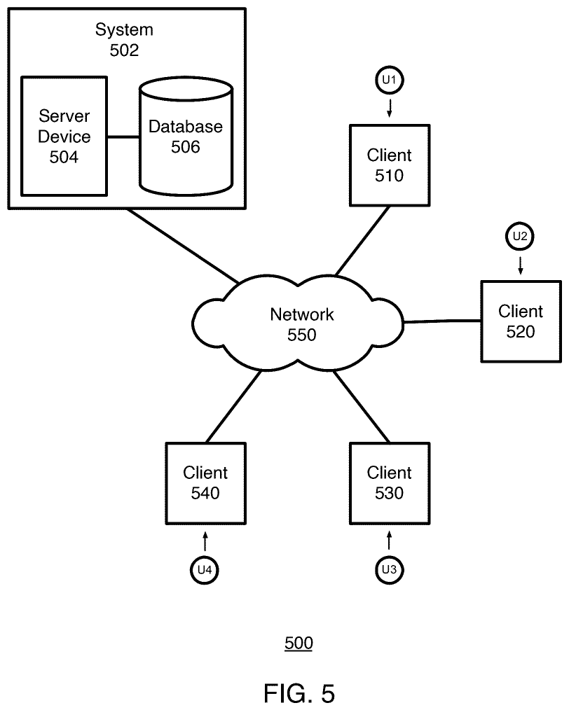

FIG. 5 is a block diagram of an example network environment 500, which may be used for some implementations described herein. In some implementations, network environment 500 includes a system 502, which includes a server device 504 and a database 506. For example, system 502 may be used to implement system 102 of FIG. 1 and/or system 202 of FIG. 2 as well as to perform implementations described herein. Network environment 500 also includes client devices 510, 520, 530, and 540, which may communicate with system 502 and/or may communicate with each other directly or via system 502. Network environment 500 also includes a network 550 through which system 502 and client devices 510, 520, 530, and 540 communicate. Network 550 may be any suitable communication network such as a Wi-Fi network, Bluetooth network, the Internet, etc.

For ease of illustration, FIG. 5 shows one block for each of system 502, server device 504, and network database 506, and shows four blocks for client devices 510, 520, 530, and 540. Blocks 502, 504, and 506 may represent multiple systems, server devices, and network databases. Also, there may be any number of client devices. In other implementations, environment 500 may not have all of the components shown and/or may have other elements including other types of elements instead of, or in addition to, those shown herein.

While server device 504 of system 502 performs implementations described herein, in other implementations, any suitable component or combination of components associated with system 502 or any suitable processor or processors associated with system 502 may facilitate performing the implementations described herein.

In the various implementations described herein, a processor of system 502 and/or a processor of any client device 510, 520, 530, and 540 cause the elements described herein (e.g., information, etc.) to be displayed in a user interface on one or more display screens.

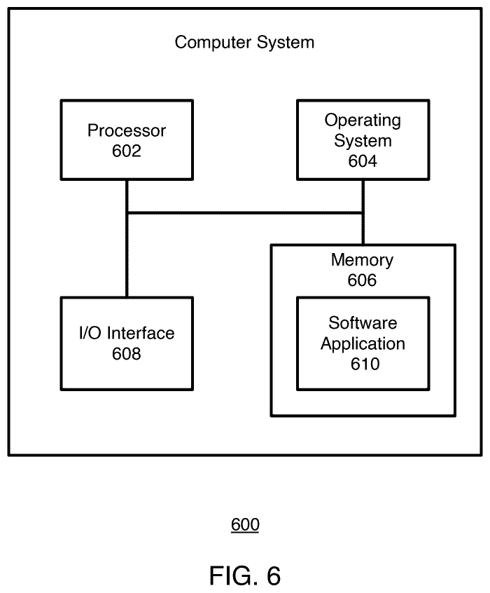

FIG. 6 is a block diagram of an example computer system 600, which may be used for some implementations described herein. For example, computer system 600 may be used to implement system 102 of FIG. 1 and/or system 202 of FIG. 2 and/or system 502 of FIG. 5, as well as to perform implementations described herein. In some implementations, computer system 600 may include a processor 602, an operating system 604, a memory 606, and an input/output (I/O) interface 608. In various implementations, processor 602 may be used to implement various functions and features described herein, as well as to perform the method implementations described herein. While processor 602 is described as performing implementations described herein, any suitable component or combination of components of computer system 600 or any suitable processor or processors associated with computer system 600 or any suitable system may perform the steps described. Implementations described herein may be carried out on a user device, on a server, or a combination of both.

Computer system 600 also includes a software application 610, which may be stored on memory 606 or on any other suitable storage location or computer-readable medium. Software application 610 provides instructions that enable processor 602 to perform the implementations described herein and other functions. Software application may also include an engine such as a network engine for performing various functions associated with one or more networks and network communications. The components of computer system 600 may be implemented by one or more processors or any combination of hardware devices, as well as any combination of hardware, software, firmware, etc.

For ease of illustration, FIG. 6 shows one block for each of processor 602, operating system 604, memory 606, I/O interface 608, and software application 610. These blocks 602, 604, 606, 608, and 610 may represent multiple processors, operating systems, memories, I/O interfaces, and software applications. In various implementations, computer system 600 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C #, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to cause the one or more processors to perform operations comprising:
detecting that a media item is being presented on a media device;
generating media information associated with the media item while the media item is being presented on the media device, wherein the media information comprises a description and analysis of content presented in association of the media item; and
providing the media information to a user of the media device.

2. The system of claim 1, wherein the media item is a movie or a television show.

3. The system of claim 1, wherein the media information comprises people information about people associated with a creation of the media item.

4. The system of claim 1, wherein the media information comprises content information about content associated with the media item.

5. The system of claim 1, wherein the logic when executed is further operable to cause the one or more processors to perform operations comprising performing a search for media information based on content associated with the media item, wherein the content is currently being presented on the media device.

6. The system of claim 1, wherein the logic when executed is further operable to cause the one or more processors to perform operations comprising displaying the media information to the user, wherein the media information is displayed based on content that is currently being presented on the media device.

7. The system of claim 1, wherein the logic when executed is further operable to cause the one or more processors to perform operations comprising performing an analysis of the media information while the media item is being presented to a user.

8. A non-transitory computer-readable storage medium with program instructions stored thereon, the program instructions when executed by one or more processors are operable to cause the one or more processors to perform operations comprising:
detecting that a media item is being presented on a media device;
generating media information associated with the media item while the media item is being presented on the media device, wherein the media information comprises a description and analysis of content presented in association of the media item; and
providing the media information to a user of the media device.

9. The computer-readable storage medium of claim 8, wherein the media item is a movie or a television show.

10. The computer-readable storage medium of claim 8, wherein the media information comprises people information about people associated with a creation of the media item.

11. The computer-readable storage medium of claim 8, wherein the media information comprises content information about content associated with the media item.

12. The computer-readable storage medium of claim 8, wherein the instructions when executed are further operable to cause the one or more processors to perform operations comprising performing a search for media information based on content associated with the media item, wherein the content is currently being presented on the media device.

13. The computer-readable storage medium of claim 8, wherein the instructions when executed are further operable to cause the one or more processors to perform operations comprising displaying the media information to the user, wherein the media information is displayed based on content that is currently being presented on the media device.

14. The computer-readable storage medium of claim 8, wherein the instructions when executed are further operable to cause the one or more processors to perform operations comprising performing an analysis of the media information while the media item is being presented to a user.

15. A computer-implemented method comprising:
detecting that a media item is being presented on a media device;
generating media information associated with the media item while the media item is being presented on the media device, wherein the media information comprises a description and analysis of content presented in association of the media item; and
providing the media information to a user of the media device.

16. The method of claim 15, wherein the media item is a movie or a television show.

17. The method of claim 15, wherein the media information comprises people information about people associated with a creation of the media item.

18. The method of claim 15, wherein the media information comprises content information about content associated with the media item.

19. The method of claim 15, further comprising performing a search for media information based on content associated with the media item, wherein the content is currently being presented on the media device.

20. The method of claim 15, further comprising displaying the media information to the user, wherein the media information is displayed based on content that is currently being presented on the media device.
